(19) United States
(12) Patent Application Publication
(10) Pub. No.: US 2013/0240667 A1
(43) Pub. Date: Sep. 19, 2013

(54) Aircraft comprising fairings for correcting its dissymmetry or lateral asymmetry

(71) Applicant: AIRBUS OPERATIONS (SAS), Toulouse (FR)

(72) Inventors: Cyril Guichot, Toulouse (FR); Fabien Latourelle, Toulouse (FR)

(73) Assignee: AIRBUS OPERATIONS (SAS), Toulouse (FR)

(21) Appl. No.: 13/793,222

(22) Filed: Mar. 11, 2013

(30) Foreign Application Priority Data
Mar. 13, 2012 (FR) 1252236

(51) Int. Cl. B64C 7/00

(52) U.S. Cl. CPC B64C 7/00
USPC 244/75.1

(57) ABSTRACT

An aircraft having an asymmetry or a lateral geometric dissymmetry and comprising at least one pair of wings to each of which are fixed at least one fairing, each fairing comprising a surface connected to the lower surface of the wing and extending longitudinally in the direction of a longitudinal axis of the fuselage. The surface of at least one of the fairings has at least one local geometric deformation which is suitable for producing a corrective rolling moment to compensate for the undesirable rolling moment produced by the asymmetry or the lateral dissymmetry of the aircraft.

### CROSS-REFERENCES TO RELATED APPLICATIONS

This application claims the benefit of the French patent application No. 12 52236 filed on Mar. 13, 2012, the entire disclosures of which are incorporated herein by way of reference.

### BACKGROUND OF THE INVENTION

The invention relates to an aircraft.

Aircraft are generally equipped with numerous devices which are situated under their wing systems (on the lower surface of their wings for example). Fairings are arranged on or around these devices in order to limit the impact of their presence on the aerodynamic performances of the apparatus.

However, depending on their arrangement, the presence of these devices and associated fairings can produce an asymmetry or lateral dissymmetry of the wing system. In other words the center of gravity of the aircraft thus equipped is not situated in the plane of symmetry of the wings.

By way of example, a backup wind power system or RAT (“Ram Air Turbine”), which is deployed in the event of failure of the energy sources of the engines, is available on only one of the wings. Its presence therefore causes a lateral asymmetry. Other components not situated on the wings (on the fuselage for example) can also cause an asymmetry.

In another hypothetical case where each of the wings has the same number of fairings, the volume and/or the mass of the latter can vary from one wing to the other, producing a lateral dissymmetry.

During a flight, such a dissymmetry or asymmetry gives rise to an undesirable constant rolling moment that it is preferable to correct.

To this end, it is known to extend the flaps on take-off in order to produce a rolling moment opposite to that produced by the dissymmetry or the asymmetry.

Alternatively, it is known to fix blocks on the lower surface of the outer flap, for example using bolts, in order to obtain a similar effect by modifying the airflow and the local lift of the wing concerned.

However, both these solutions have disadvantages.

In fact, the preventive extension of the flap requires a significant implementation time. Moreover, this operation is to be repeated for each flight. This therefore results not only in loss of time, but in loss of energy for implementing this solution.

As regards the blocks, they increase the load on the flap, induce a drag phenomenon, and produce manufacturing constraints on the thickness of the base of the flap. This leads to a loss of fuel and an increase in manufacturing costs.

The invention is proposed to remedy at least one of these drawbacks.

### SUMMARY OF THE INVENTION

The invention relates to an aircraft comprising a fuselage and at least one pair of wings arranged on either side of the fuselage symmetrically with respect to a plane of symmetry of the wings, at least one fairing being fixed to each of the wings, each fairing comprising a fairing surface connected to the lower surface of the wing and extending longitudinally in the direction of the longitudinal axis of the fuselage, the aircraft having an asymmetry or a lateral dissymmetry such that the center of gravity of the aircraft is not situated in the plane of symmetry of the wings.

The fairing surface is provided at least one local geometric deformation which is suitable for producing a corrective rolling moment to compensate for the undesirable rolling moment produced by the asymmetry or the lateral dissymmetry of the aircraft.

A fairing according to the invention thus makes it possible to produce a dissymmetry of lift between the two wings, which induces, via the lever arm between the center of gravity of the aeroplane and the point of application of the lift, a rolling moment correcting the asymmetry or the lateral dissymmetry of the aeroplane.

This rolling moment produces an effect equivalent to a pre-extension of the flaps.

Thanks to these arrangements, any modification of the trailing edge of a device to which the fairing is applied is avoided. There is also no further increase in the load on the wing system.

The implementation of such a solution is also simple, economic and definitive, unlike a preventive extension of the flaps which must be carried out for each flight.

In particular, the modification of the fairing is carried out so as to retain a useful ratio between the roll rate obtained and the drag induced.

According to a possible characteristic of the invention, the wings comprise flaps and the fairings having a local geometric deformation are “flap track fairings.”

According to a possible characteristic of the invention, the local deformation comprises an elongation of the fairing in the direction of the longitudinal axis of the fuselage.

This is a design that is easy to implement starting from a standard fairing structure.

More particularly, the elongation of the fairing is carried out towards the front of the aircraft.

A configuration towards the front makes it possible to take better advantage of the lift effect created by the elongation and to reduce any effects of turbulence.

This elongation for example represents an increase of the order of 20% of its initial length.

This is a reasonable elongation making it possible to create a sufficient rolling moment without modifying the design of the fairing too much.

Such an increase (and, more generally, said at least one local geometric deformation) has a location and an amplitude which depend in particular on aerodynamic parameters of the aircraft.

In order to obtain the sought effect on the lift of the wing system, it is preferable to take account of these parameters in order to locally shape the fairing surface concerned.

These aerodynamic parameters are, according to a possible characteristic of the invention, those relating to the fuselage, to the wings, to the engine nacelles and to the speed of the aircraft.

According to a possible characteristic of the invention, said at least one local geometric deformation comprises a modification of the local radius of curvature of at least one area of the fairing surface considered.

According to a possible characteristic of the invention, said at least one local geometric deformation comprises the addition of a local convexity.

This makes it possible to locally modify the lift and therefore to influence the roll rate of the aircraft.

More particularly, the local convexity is in the shape of a bulge.

According to a possible characteristic, the bulge is situated at the front of the fairing.

### BRIEF DESCRIPTION OF THE DRAWINGS

Other characteristics and advantages will become apparent during the following description which is given as a non-limitative example with reference to the attached drawings, in which:

FIG. 1 is a diagrammatic representation of a cross-section of an aircraft according to the invention;

FIG. 2 is a diagrammatic representation of a bottom view of a wing of the aircraft of FIG. 1;

FIG. 3 is a diagrammatic representation of a longitudinal section of the wing of FIG. 2.

### DETAILED DESCRIPTION OF THE PREFERRED EMBODIMENTS

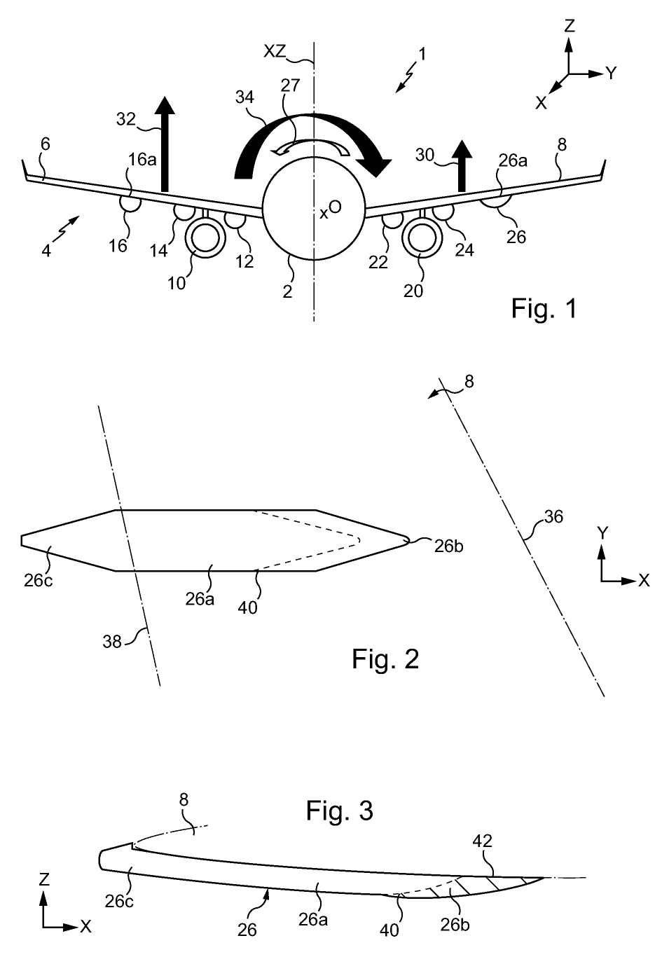

An aircraft according to the invention is shown in FIG. 1.

This aircraft 1 comprises a fuselage 2 and a wing system 4.

The wing system 4 comprises a left wing 6 and a right wing 8 (the left and the right being those of FIG. 1), symmetrical with respect to the longitudinal plane XZ, X being the longitudinal axis of the fuselage 2. The longitudinal plane XZ is a vertical plane when the aircraft is on the ground.

Arranged under the left wing 6 (fixed to its lower surface) are located an engine 10, for example a turboreactor, as well as, successively, a first left fairing 12 (closest to the fuselage), a second left fairing 14 and a third left fairing 16 (furthest from the fuselage).

Similarly, arranged under the right wing 8 are located a right engine 20, as well as a first right fairing 22 (closest to the fuselage), a second right fairing 24 and a third right fairing 26 (furthest from the fuselage).

Each of the fairings is arranged around a certain number of devices (not shown) so as to limit the impact of the presence of the latter on the aerodynamics of the aeroplane.

These devices each have a mass, a volume and/or an arrangement which are such that the center of gravity O of the aeroplane is not situated on the plane XZ but offset with respect to the latter.

Therefore, during flight, an undesirable rolling moment 27 about the axis X is produced. The invention is aimed at remedying this.

In the embodiment of the invention presented in this figure, the fairings are six in number, with three per wing. However, this number as well as the manner in which they are distributed on each wing can vary.

The first left fairing 12 and the first right fairing 22 are here identical and arranged on their respective wings symmetrically with respect to the plane XZ. The same applies to the second left fairing 14 and the second right fairing 24.

The third right fairing 26, on the other hand, is different in shape from the third left fairing 16. In particular, it extends over the lower surface of the right wing 8 over a surface 26a that is wider in the direction of the elongation of the right wing 8 than the surface 16a over which the third fairing 16 extends.

Therefore, during flight, the right wing 8 will be subjected to a right lift force 30 different in value from that of the left lift force 32 to which the left wing 6 is subjected.

The difference in value of the forces 30, 32 produces a corrective rolling moment 34 about the axis X.

According to the invention, the shape of the third right fairing 26 is chosen such that the corrective rolling moment 34 produced compensates for the undesirable rolling moment 27.

The location and the amplitude of one or more shapes or geometric deformations conferred locally upon the surface of the third right fairing 28 depend in particular on aerodynamic parameters of the aircraft so as to modify the local lift at the level of the fairing.

These parameters are in particular the speed of the aircraft and parameters relating to the fuselage, the wing system and the engines.

A more precise description will now be given of the shape of the third right flap fairing 26 with reference to FIGS. 2 and 3 which show it in bottom view and in longitudinal section (plane XZ). Also shown in dotted lines is the profile of the surface of the fairing (which corresponds for example to the profile of the other fairings in FIG. 1) in the absence of the invention.

It will be noted that in these two figures, the front of the aircraft is situated towards the right, whereas the rear is situated towards the left.

The flap fairing 26 has a rotational shape symmetrical with respect to the axis X extending longitudinally along the fuselage and the axis Y perpendicular to the latter.

It comprises a substantially cylindrical central part 26a, a proximal part 26b situated at the end of the central part closest to the leading edge 36 of the wing 8, and a distal part 26c situated at its opposite end.

The proximal and distal parts each have a shape for example which tapers towards their free end.

In the embodiment associated with this figure, the proximal 26b and distal 26c parts are situated at an equal distance from the center of the central part 26a, but other configurations can be envisaged.

It will be noted in this regard that the fairing 26 is situated on the lower surface of the wing 8 so that the start of the distal part 26c which gradually tapers is situated below the trailing edge 38 of the wing.

The distal part 26c has a general ogive shape, the tip of which is cut in the plane YZ, or in other words, flat.

The angle formed between the central part 26a and the inclined wall of the distal part 26c is acute here, but can vary.

As can be seen in FIG. 3, the distal part 26c constitutes in its upper part an elongation of the wing 8 and is in this respect arranged locally flush with the upper surface of the latter.

As for the proximal part 26b, it comprises a local geometric deformation of its outer surface starting from its junction 40 with the central part 26a.

In the embodiment associated with FIGS. 2 and 3, this local deformation corresponds to a local convexity, or bulge, which extends mainly longitudinally along the fuselage (along the axis X) and, in less pronounced manner, along the axis Z.

This is a kind of double convexity which extends in two perpendicular directions. It should be noted that the double convexity can be accompanied by a third convexity in the third direction Y according to a variant.

According to other variants, the double convexity can extend in different directions such as X and Y or Y and Z.

It will be noted that the convexity can alternatively be simple and extend, for example, only along one axis such as the axis X.

Everything that has just been said about the convexities applies to other types of fairings and to other aircraft configurations.

As can be seen with respect to the dotted line, the elongation of the fairing along the axis X induced by the deformation of the proximal part 26b represents an increase of 20% of its initial length.

More precisely, the gap between the inner surface of the proximal part 26b and the lower surface of the right wing 8 increases from the lower surface of the junction 40 with the central part 26a up to the junction with the lower surface 42.

However, a constant radius of curvature can alternatively be envisaged, as well as a non-linear progression of the latter.

In any case, such a local geometric deformation is capable of modifying, in controlled manner, the airflow under the wing system, which produces a difference in lift with respect to a fairing situated on the opposite wing, such as for example the third left fairing 16.

This dissymmetry of lift (difference between the left 32 and right 30 lift forces) induces, via the lever arm between the center of gravity of the aeroplane and the point of application of the lift, the corrective rolling moment 34 which corrects the lateral geometric dissymmetry of the aeroplane by compensating for the undesirable moment 27.

The geometric deformation is in particular produced as a function of the desired corrective moment. It thus depends on the flight conditions, parameters associated with the aircraft and on-board systems such as RAF systems.

To this end, its location along the central part 26a and the amplitude of its radius of curvature are varied.

On an A330 or A300 type aircraft, numerical calculations have made it possible to evaluate the impact of the modification of the shape of the third right fairing 26 on the roll at cruising speed. The roll rate is thus modified so as to correspond to a DCI (“Design Change Instruction”) of −0.0005.

Moreover, advantageously, the impact on the drag coefficient is negligible for a range of use of the aircraft (value of the difference in “drag count” of less than 0.1, i.e. 0.04% drag).

In another embodiment, not shown, other fairings, in addition to or instead of the third right fairing 26, can be provided with one or more local geometric deformations depending on where the devices producing the lateral asymmetry of the aircraft are positioned.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An aircraft comprising a fuselage and at least one pair of wings arranged on either side of the fuselage symmetrically with respect to a plane of symmetry of the wings, at least one fairing being fixed to each of the wings, each fairing comprising a fairing surface connected to the lower surface of the wing and extending longitudinally in the direction of a longitudinal axis of the fuselage, the aircraft having an asymmetry or a lateral dissymmetry such that a center of gravity of the aircraft is not situated in the plane of symmetry of the wings, wherein said fairing surface has at least one local geometric deformation which is suitable for producing a corrective rolling moment to compensate for the undesirable rolling moment produced by the asymmetry or the lateral dissymmetry of the aircraft.

2. The aircraft according to claim 1, wherein the wings comprise flaps, the fairings which have a local geometric deformation being flap track fairings.

3. The aircraft according to claim 1, wherein said at least one local geometric deformation comprises an elongation of the fairing in the longitudinal direction of the axis of the fuselage.

4. The aircraft according to claim 3, wherein the elongation of the fairing is carried out towards a front of the aircraft.

5. The aircraft according to claim 3, wherein the elongation of the fairing represents an increase of 20% of its initial length.

6. The aircraft according to claim 1, wherein said at least one local geometric deformation has a location and an amplitude which depend in particular on aerodynamic parameters of the aircraft.

7. The aircraft according to claim 6, wherein the aerodynamic parameters are those relating to the fuselage, to the wings, to engine nacelles and to the speed of the aircraft.

8. The aircraft according to claim 1, wherein said at least one local geometric deformation comprises a modification of the local radius of curvature of at least one area of the fairing surface.

9. The aircraft according to claim 1, wherein said at least one local geometric deformation comprises a local convexity.

10. The aircraft according to claim 9, wherein the local convexity is in the shape of a bulge.

11. The aircraft according to claim 10, wherein the bulge is situated at a front of the fairing.
